(19) United States
(12) Patent Application Publication
(10) Pub. No.: US 2009/0293691 A1
(43) Pub. Date: Dec. 3, 2009

(54) Detent Switch for a Power Tool

(76) Inventor: Robert S. Gehret, Hampstead, MD (US)

Correspondence Address: THE BLACK & DECKER CORPORATION, 701 EAST JOPPA ROAD, TW199, TOWSON, MD, 21286, US

(21) Appl. No.: 12/468,273

(22) Filed: May 19, 2009

Related U.S. Application Data
(60) Provisional application No. 61/129,031, filed on May 30, 2008.

(51) Int. Cl. B27B 5/20; B23D 45/04; B26D 5/00

(52) U.S. Cl. 83/57; 83/471.3; 83/34

(57) ABSTRACT

A power tool including a bevel mechanism for selectively determining a bevel cutting angle of the power tool, a bevel drive motor operably connected to the bevel mechanism that drives the bevel mechanism, and a switch connected to tile bevel drive motor that activates/deactivates the motor. The bevel drive motor may drive the bevel mechanism to lock/unlock the saw from a current position to allow a user to rotate a saw about a bevel axis. The switch may also activate release of a detent to allow the bevel angle to be set at a desired position. The switch may be mounted, for example, on an operating handle of the saw in a position easily accessible by the user. The output of the switch may be connected to a controller used to control operation of the motor.

### CROSS-REFERENCE TO RELATED APPLICATIONS

This application claims the benefit of U.S. Provisional Application No. 61/129,031 filed on May 30, 2008. The disclosure of the above application is incorporated herein by reference in its entirety.

### FIELD OF THE INVENTION

The present invention relates to power operated tools or machinery for performing working operations on a workpiece. More particularly, the present invention relates to improvements to a bevel detent control on a power miter saw.

### BACKGROUND OF THE INVENTION

Saws and other apparatuses designed for cutting or performing other working operations on a workpiece typically require adjustment mechanisms for moving the saw blade or cutting tool into an angular relationship to the workpiece. Examples of such equipment include cross-cut compound miter saws which are adapted for allowing the user to selectively move the saw blade into any of a number of positions or modes for square cutting, miter cutting, bevel cutting, or compound miter cutting where a combination miter angle and bevel angle are cut. In addition, some operations, such as dado cutting or shaping operations, for example, require the use of saw blades or other cutting or working devices of different shapes or sizes to be substituted for one another in order to perform the desired operation on the workpiece, whether the workpiece is composed of wood, plastic, metal or other materials.

To allow for the adjustment of the miter and the bevel angle, the saw blade, cutter or other working device is angularly adjustable with respect to a horizontal base and a vertical fence against which the workpiece is positioned. The miter adjustment allows the saw blade, cutter or other working device to move angularly with respect to the vertical fence while maintaining perpendicularity with the horizontal base. The bevel adjustment allows the saw blade, cutter or other working device to move angularly with respect to the horizontal base while maintaining perpendicularity with the vertical fence.

Bevel angle adjustment may require a user to set a detent to one of several predetermined angles by releasing a bevel adjustment lock and lifting a detent out of notch in a detent plate that is representative of a predetermined position in a detent plate, rotating the saw about a bevel axis to another predetermined position in the detent plate and allowing the detent to snap into another notch in the detent plate representative of a desired bevel angle.

Bevel adjustment mechanisms need to be easily activated and adjustable to optimize cutting efficiency and convenience.

Once the saw blade, cutter or other working device has been adjusted to the desired position with respect to the horizontal base and the vertical fence, locking mechanisms for the miter and bevel adjustment must be activated in order to prohibit movement of the saw blade, cutter or other working device with respect to the base and fence while the cutting operation is performed. These locking mechanisms need to be easily activated, adjustable and quick acting in order to optimize the efficiency of the cutting apparatus and provide convenience to the operator of the apparatus.

It is also advantageous to provide bevel stop mechanisms so that operators can change and easily locate common bevel angles. These bevel stop mechanisms need to be easily engaged and disengaged, adjustable and quick acting in order to optimize the efficiency of the cutting apparatus and provide convenience to the operator of the apparatus.

### SUMMARY OF THE INVENTION

In accordance with the present invention, an improved bevel adjustment device is employed in a power tool, such as a miter saw. In an exemplary embodiment, the miter saw includes a table on which a workpiece is placed, a miter saw unit supporting a saw blade and having a motor for rotatably driving the saw blade, and a housing pivotally supporting the miter saw unit related to the table in such a manner that the miter saw unit is at least laterally pivotable. Further, the miter saw includes a bevel mechanism for selectively determining the angular position of the miter saw unit at any of a plurality of pivoted positions including a vertical position where the saw blade is positioned substantially vertically relative to the table, and leftward and rightward pivoted positions where the blade is inclined laterally leftwardly and laterally rightwardly from the vertical position.

The bevel adjustment device includes a switch mountable on the saw, a controller, and a motor that drives a mechanism to lock/unlock the saw from a current position to allow a user to rotate a saw about a bevel axis. The switch may also activate release of the detent from a lifted position to allow the bevel angle to be set to a desired position. The switch may be mounted, for example, on an operating handle of the saw in a position easily accessible by the user. The output of the switch may be connected to a controller used to control operation of the motor to activate actuators that move the detent.

Other advantages and objects of the present invention will become apparent to those skilled in the art from the subsequent detailed description, appended claims and drawings.

### BRIEF DESCRIPTION OF THE DRAWINGS

The present invention will become more fully understood from the detailed description given below and the accompanying drawings, which are given for purposes of illustration only, and thus do not limit the invention. In the drawings which illustrate the best mode presently contemplated for carrying out the present invention:

FIG. 1 is a side perspective view of a sliding compound miter saw in accordance with the present invention;

FIG. 2 is a front perspective view of the sliding compound miter saw shown in FIG. 1:

FIG. 3 is a rear perspective view of the sliding compound miter saw shown in FIGS. 1 and 2;

FIG. 4 is a side perspective view of the sliding compound miter saw shown in FIGS. 1 through 3;

FIG. 5 is an exploded perspective view of an example embodiment of the bevel stop mechanism of the sliding compound miter saw shown in FIGS. 1 through 4;

FIG. 6 is a partially assembled perspective view, partially in cross-section of the bevel stop mechanism of the sliding compound miter saw shown in FIGS. 1 through 4;

FIG. 7 is a cross-sectional side view of an example embodiment of the bevel stop mechanism;

FIG. 8 is an end view of the base or table assembly illustrating an example embodiment of the adjustment feature provided for the bevel stop mechanism shown in FIG. 5;

FIG. 9 is a perspective view of an operating handle of a sliding compound miter saw shown in FIGS. 1-5;

FIG. 10 is a front view of a bevel adjust switch on an operating handle of a sliding compound miter saw shown in FIGS. 1-5;

FIG. 11 is a perspective view of a detent plate and detent of a bevel adjustment device, according to an example embodiment;

FIG. 12 is a side view of an actuating apparatus of a bevel adjustment device of a sliding compound miter saw, according to an example embodiment;

FIG. 13 is an exploded perspective view of an example embodiment of the bevel stop mechanism of a sliding compound miter saw, according to an example embodiment; and

FIG. 14 is an exploded perspective view of an example embodiment of the bevel stop mechanism of a sliding compound miter saw.

### DETAILED DESCRIPTION OF THE EXEMPLARY EMBODIMENTS

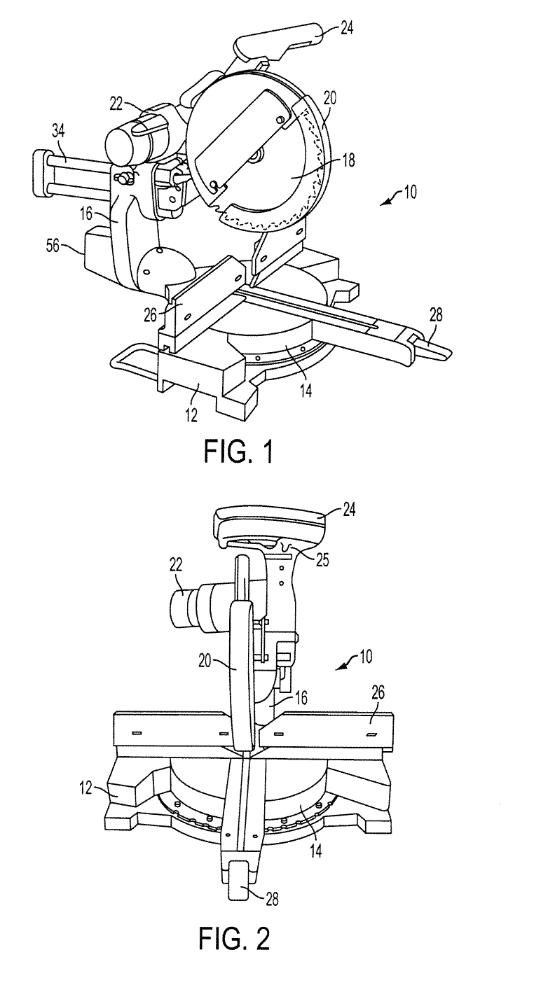

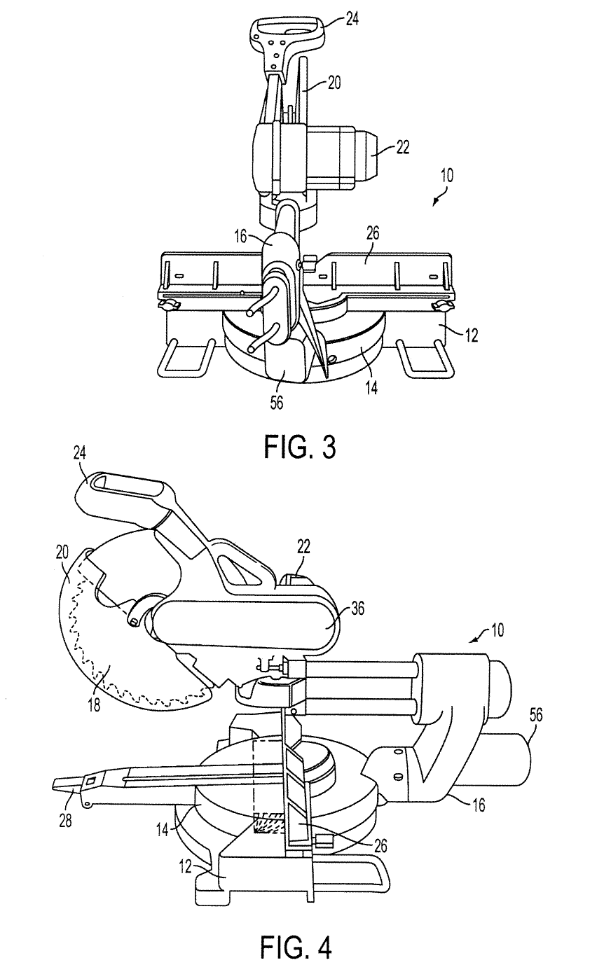

Referring now to the drawings in which like reference numerals designate like or corresponding parts throughout the several views, there is shown in FIGS. 1 through 4 an exemplary sliding compound miter saw incorporating a bevel adjustment device according to the present invention, shown merely for the purposes of illustration, and designated generally by the reference numeral 10. One skilled in the art will readily recognize from the following description, taken in conjunction with the accompanying drawings and claims, that the principles of the present invention are equally applicable to other power tools, including but not limited to, sliding compound miter saws, compound miter saws, chop saws, radial arm saws, table saws, jigsaws, scroll saws, or other saws of types other than that shown for purposes of illustration in the drawings. Some specific examples of saws to which principles of the invention can be applied include the DeWalt DW706 or DW718 power miter saws. Similarly, one skilled in the art will readily recognize that the principles of the bevel adjustment according to the present invention are also applicable to other types of powered equipment for performing an operation on a workpiece. Such equipment includes, but is not limited to, dado saws, spindle shapers or sanders, or other types of powered devices that would benefit from the cam locking mechanism of the present invention.

Referring primarily to FIGS. 1 through 4, a sliding compound miter saw 10 includes a base assembly 12, a table assembly 14, a housing assembly 16, a saw blade 18, a blade guard 20, a motor 22 drivingly connected to saw blade 18, a bevel drive motor housing 56, an operating handle 24 and a fence assembly 26. Table assembly 14 is secured to base assembly 12 such that it can be rotated to provide adjustment for miter cutting. The rotation of table assembly 14 changes the angle of saw blade 18 relative to fence assembly 26 but maintains the perpendicularity of saw blade 18 with table assembly 14. A locking mechanism 28 can be activated in order to lock table assembly 14 to base assembly 12.

The housing assembly 16 is secured to table assembly 14 such that it can be pivoted with respect to table assembly 14 to provide adjustment for bevel cutting. As can be appreciated by one skilled in the art, the adjustments for mitering and bevelling can be separate. The pivoting of housing assembly 16 changes the angle of saw blade 18 relative to table assembly 14 but maintains the miter angle of saw blade 18 with respect fence assembly 26. A locking mechanism contained within bevel drive motor housing 56, can be activated/deactivated to lock/unlock housing assembly 16 to table assembly 14 at a desired bevel angle.

Referring to FIGS. 1 through 9, the housing assembly 16 includes support housing 32, which mounts a pair of support arms 34 for sliding movement with respect to housing 32. Saw blade 18, blade guard 20, motor 22 and operating handle 24 are all mounted to a drive housing 36 which is pivotably secured to support arms 34. While the support arms 34 are shown one above the other, in other embodiments the support arms could be in a side-by-side configuration. The pivoting of drive housing 36 downward towards table assembly 14 operates to open blade guard 20 and cuts a workpiece which is supported by table assembly 14 and fence assembly 26. The sliding movement of support arm 34 relative to housing 32 permits drive housing 36 and thus saw blade 18 to be pulled through the workpiece when the size of the workpiece exceeds the cutting width of saw blade 18.

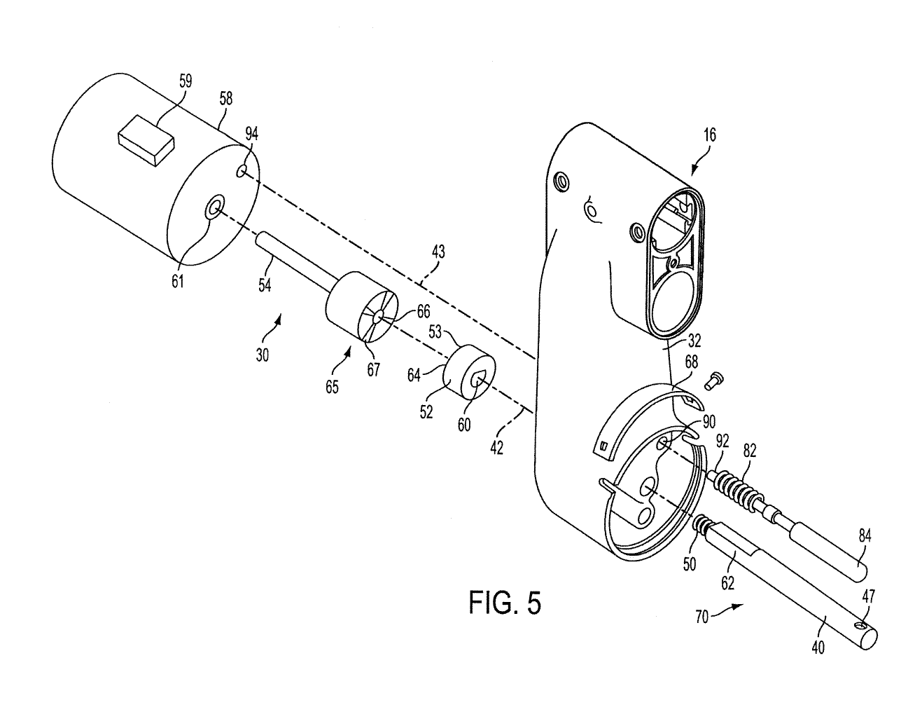

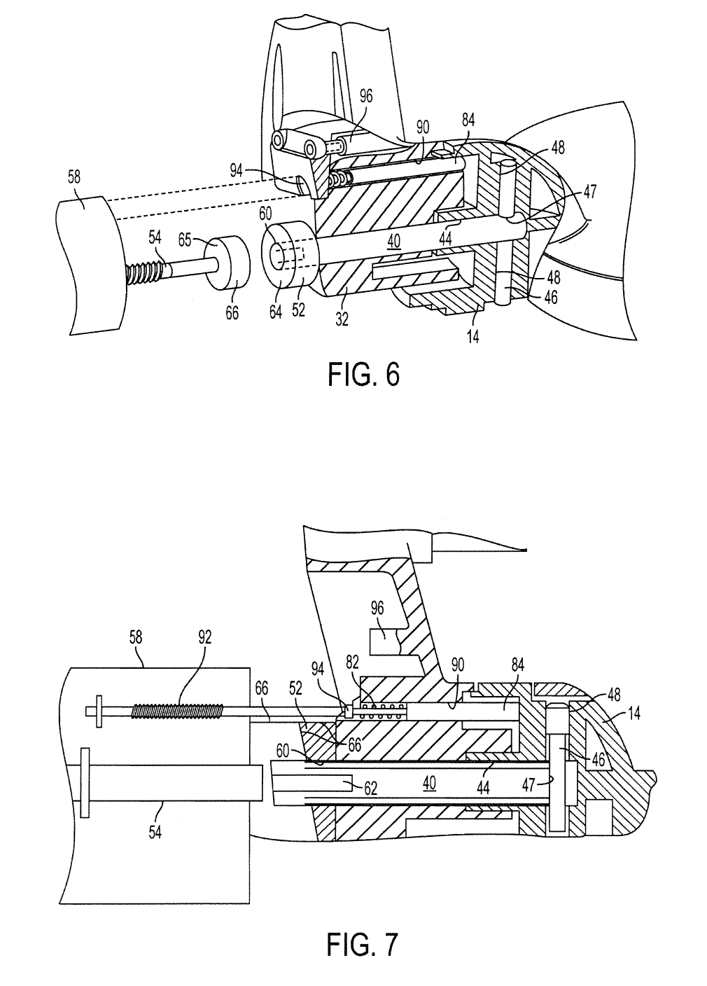

Referring to FIGS. 5 and 6, support housing 32 is pivotably supported with respect to table assembly 14 on a steel shaft 40 which is secured to table assembly 14 and extends rearwardly from table assembly 14 to define a pivot axis 42 for support housing 32. Shaft 40 is inserted into a complimentary bore 44 located within table assembly 14 and is secured in place using a cross pin 46 which extends through a bore 47 extending through shaft 40 and a corresponding set of bores 48 located within table assembly 14 and being generally perpendicular to and extending into bore 44. The end of shaft 40 opposite to the end extending through bore 46 includes a threaded stub 50 for retaining and adjusting locking mechanism 30 as will be described later herein.

Locking mechanism 30 includes a motor 58, a controller 59, a rod 54, a cam 65 having a plurality of ramps 67 on a surface 66 and cam 52. Once support housing 32 is slidingly and pivotably received on shaft 40, cam 52 is slidingly positioned on shaft 40 adjacent support housing 32. Cam 52 includes a D-shaped through bore 60 which mates with a corresponding D-shaped portion 62 of shaft 40 such that cam 52 is allowed to move axially along portion 62 of shaft 40 but rotation of cam 52 with respect to shaft 40 is prohibited. Cam 52 further includes an angular camming surface 64 having a plurality of ramps 53 which are located on the radial surface of cam 52 which is opposite to support housing 32. Camming surface 64 is designed to mate with cam 65 as will be described later herein.

As shown in FIGS. 5-7, an electric motor 58 is used to rotationally drive a rod 54 that has cam 65 attached to an end of the rod 54. The cam 65 has camming surface 66 having a plurality of ramps 67 to apply/release torque pressure when mated with camming surface 64 of cam 52 thereby locking/releasing the support housing 32. A controller 59 is used to provide signals to the motor 58 according to a position of a switch 25 (see FIG. 7). The motor 58 is operatively connected to and activated by switch 25 located on an operating handle 24 of the saw 10 to rotate the cam 65. The motor 58, rod 54, cam 65 and cam 52 handle 54 are retained in motor housing 56 attached to the support housing 32. In an example embodiment, an electric motor/actuator, such as a motor and solenoid may also be used to lock/unlock the bevel and also to lift/release the detent.

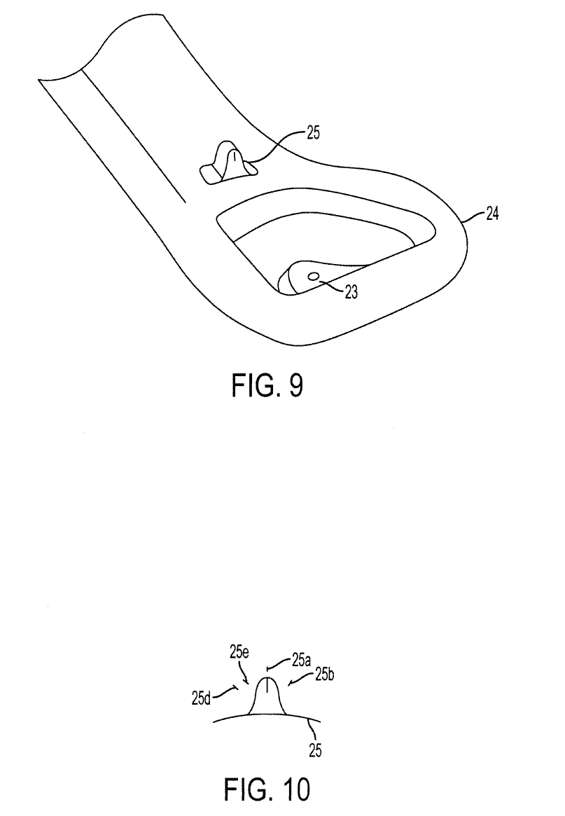

In an example embodiment, a four-position toggle switch 25 (FIGS. 9 and 10) is used to provide control of both the bevel locking mechanism 30 and a detent control system 70. The switch 25 is mounted on the operating handle 24 of the miter saw 10 within easy reach of a user's hand. The switch four-position toggle switch 25 may have a “home” position 25a, i.e., a position, that upon release, to which the switch returns. In the “home” position 25a, the bevel locking mechanism 30 is locked. The switch may have a first momentary position 25b in a first direction and two momentary positions 25c, 25d in a second position.

In normal operation, the switch 25 is in home position 25a and the bevel angle of the saw is locked. To change the saw bevel angle, the switch is moved to position 25b and motor 58 rotates rod 54 to a position where angular camming surface 64 and angular camming surface 66 are in full contact with each other as shown in FIG. 7, support housing 32 is free to pivot on shaft 40 to allow the bevel angle of saw blade 18 to be changed. Once the desired bevel angle has been set, the switch 25 is returned to home position 25a and motor 58 rotates the rod 54. Rotation of the rod 54 mis-aligns camming surfaces 64 and 66 (using the raised portion of ramps 67 and raised portions of camming surface 64 to contact each other) pushing support housing 32 and cam 52 axially along shaft 40. Support housing 32 contacts table assembly 14 and continued rotation of the rod 54 forces support housing 32 into table assembly 14 locking the two components 32, 14 together. The locking of the two components 32, 14 together can be accomplished by rotating the rod 54 in either a clockwise or a counter clockwise direction on order to misalign camming surfaces 64 and 66. This bi-directional locking ability of rod 54 simplifies the adjustment of the bevel angle on opposite sides of center. An indicator plate (not shown) may be attached to support housing 32 to allow the user to set a specific bevel angle. The indicator plate may be provided with a pair of slots which allow for the zero adjustment of the plate.

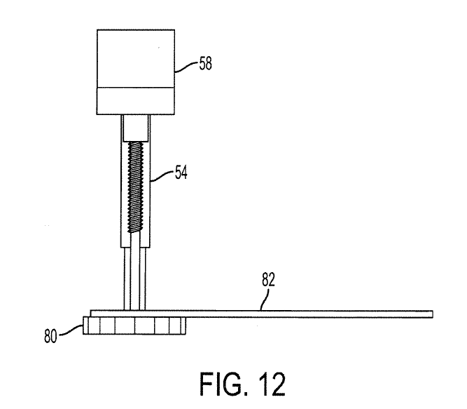

The exemplary miter saw 10 may also incorporate additional features within housing assembly 16, including a detent system 70. Referring to FIGS. 5 through 8, the detent system 70 includes a biasing spring 82, a stop rod 84, and an adjustable stop system 88. Biasing spring 82 is inserted into a stepped aperture 90 extending through support housing 32 such that the spring 82 abuts the step formed within aperture 90. Stop rod 84 is then inserted through spring 82 and through aperture 90 and into motor 58 trapping spring 82 between rod 84 and stepped aperture 90. A reduced diameter portion 92 of rod 84 extends through housing 32 and is inserted into an opening 94 in the motor 58. Once secured in the motor 58, the stop rod 84 may be moved axially within housing 32 between a stop position and a release position with spring 82 biasing stop rod 84 into its stopped position. The stop rod 84 may be a screw jack (FIG. 12) rotatable by the motor 58 to axially move the stop rod 84 axially within the housing 32.

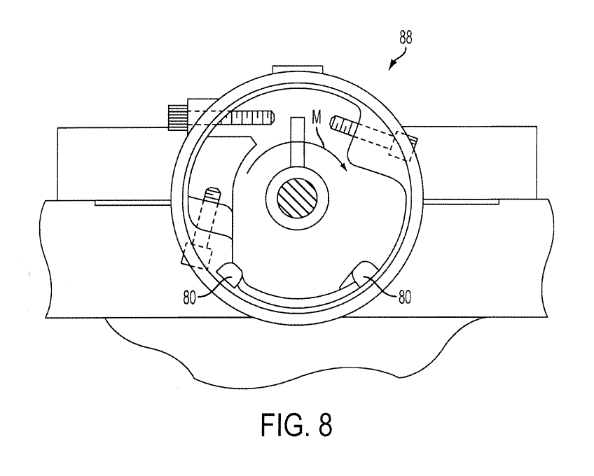

Table assembly 14 includes at least one detent. For example, as shown in FIG. 8, a pair of detents 80 is formed into the face of table assembly 14. In an example embodiment, the position of detents 80 are selected such that an end of the stop rod 84 will drop into detent 80 when the bevel angle for support housing 32 reaches 31.62° either side of center. A bevel angle of 31.62° may be desired when miter saw 10 is set to cut cove molding, for example. While the present invention is illustrated as having only one pair of detents 80, it is within the scope of the present invention to provide additional detents located at additional bevel angles which are commonly used if desired. For example, additional detents may be provided for 0° and 45° or other desired bevel angles. When located in its stopped position, stop rod 84 extends into table assembly 14 such that the stop rod can engage one of a plurality of detents 80.

In an example embodiment, to change the bevel angle of the saw 10 using the detent system 70, a user pushes the switch 25 to the second of the second momentary positions 25d sending a signal to the controller 59 to unlock the bevel locking mechanism 30 and to move the stop rod 84 against the spring 82 to move the stop rod out one of the detents 80. For example, when the bevel angle needs to be changed, the switch 25 activates motor 58 through controller 59 to rotate the rod 54 and the cam 65 to release housing 32 from table assembly 14 and the motor 58 withdraws stop rod 84 from within table assembly 14 to a position at which stop rod 84 is not in a detent 80 and the housing 32 is pivoted on shaft 40 so that the bevel angle may be changed to a desired angle.

The user may then move the saw 10 so that the bevel angle is near or at a detent 80 and release the switch 25 to a first of the second momentary positions 25c to release the rod 84 into a detent 80 in the table assembly 14. The user may also release the switch 25 to allow the rod 84 to engage the table assembly at a point where there is no detent 80, then move the saw 10 such that the stop rod 84 would snap into a detent 80 in the table assembly 14. The user may then allow the switch 25 to return to the “home” position 25a to lock the housing 32 in place. In other words, the two momentary positions 25c, 25d to the left control the detent function. With the switch 25 all the way to the left and at a second momentary position 25d the detent would be out of play. With the switch 25 in the first momentary position 25c to the left the detent function is in play and the user may move the saw 10 and allow the stop rod 84 or rod 84 to snap into a detent 80 in the table assembly 14. On the other hand, if the user wanted to set the bevel angle to an angle that is not represented by a notch or detent in the detent plate 80, the user may push the switch 25 to the right to position 25b to cause both the bevel lock mechanism 30 to be unlocked and the rod 84 to be moved out of position. The user would then set the saw 10 to the desired bevel angle and release the switch 25. When the switch has returned to the “home” position 25a, the bevel lock mechanism 30 is locked and then, after a short delay, the rod 84 is released.

As would be apparent to one of ordinary skill in the art, the switch 25 having two positions 25c, 25d to the left may be replaced with a single switch position if another means is used to lock the bevel after the detent is in position. For example, a sensor (not shown) may be used to detect position of the detent and only lock the bevel after the detent is in position, or a time delay device may be used to lock the bevel after a predetermined time upon release of the detent.

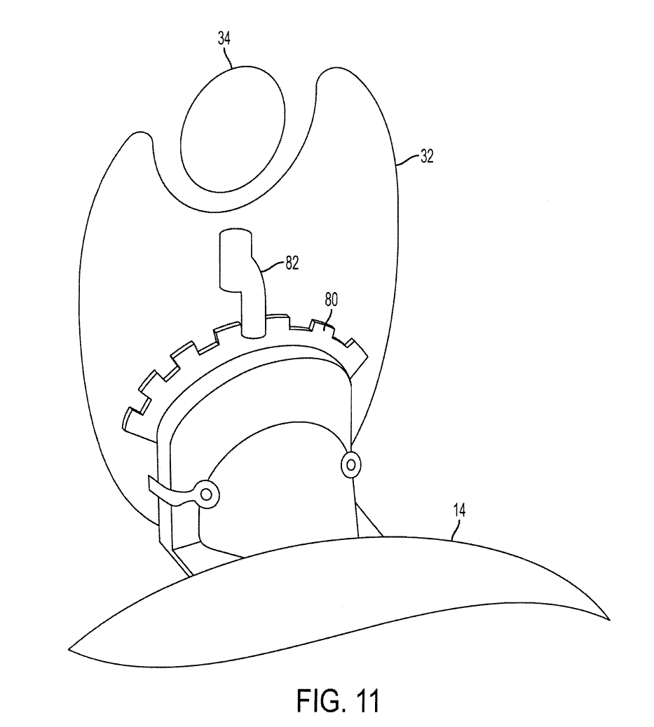

In an example embodiment, the bevel angle of the saw 10 may be changed using a detent latch 82 (FIG. 12) that engages a detent plate 80 (FIG. 11). In this example, threaded rod 84 acts perpendicular to the bevel axis to lift the detent latch 82 out of detent plate 80. In the example embodiment, a user would push the switch to the second of the second momentary positions 25d to unlock the bevel locking mechanism 30. The switch 25 would be activated causing an electric signal to be sent to the controller 59 that would rotate the rod 54 and the cam 65 thereby releasing the housing 32. A signal from the controller 59 may also rotate threaded rod 84 to lift the detent latch 82 out of one of a notch in the detent plate 80. For example, when the bevel angle needs to be changed, the motor 58 rotates the rod 54 and the cam 65 to release housing 32 from table assembly 14 and the motor 58 rotates threaded rod 84 to lift the detent latch 82 from a notch within the detent plate 80 so that the bevel angle may be changed to a desired angle (see FIG. 12). The user may then move the saw 10 so that the bevel angle is at or near a notch in the detent plate 80 representing a desired bevel angle and release the switch 25 to a first of the second momentary positions 25c, to send a signal to controller 59 that would rotate threaded rod 84 to allow detent 82 to engage a detent in detent plate 80. The user may then allow switch 25 to return to home position 25a to rotate the rod 54 and cam 65 to lock the saw 10 in place.

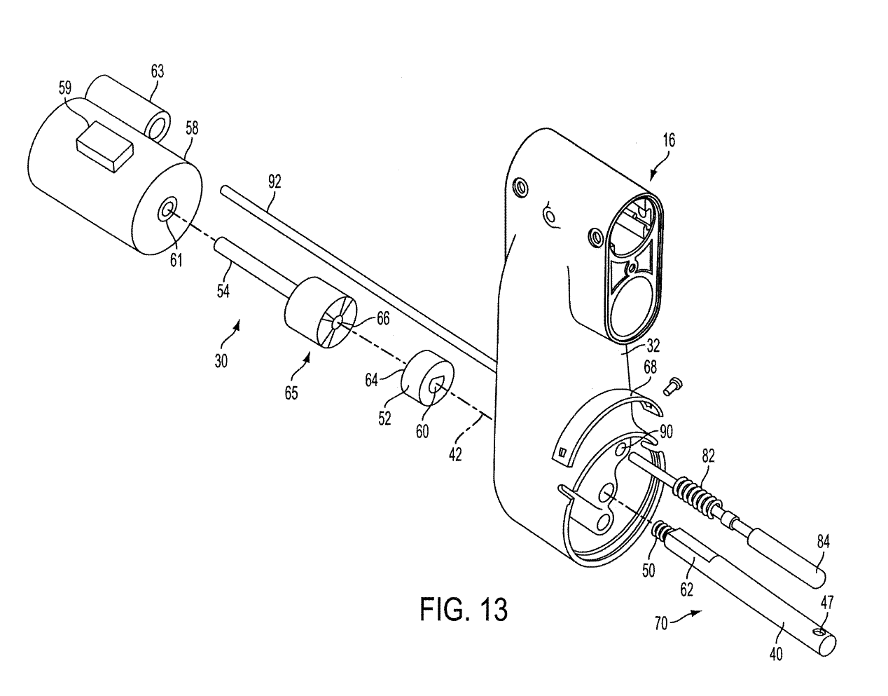

In an example embodiment, as shown in FIG. 13, a motor 58 may used in conjunction with a solenoid 63 to separately release the bevel locking mechanism 30 and to control the bevel detent system 70. In operation, a user may change the bevel angle of the saw 10 using the detent system 70, by pushing the switch 25 to a second momentary position 25d sending a signal to the controller 59 to make motor 58 unlock the bevel locking mechanism 30 and solenoid 63 to move the stop rod 84 against the spring 82 to move the stop rod out one of the detents 80. For example, when the bevel angle needs to be changed, the switch 25 activates motor 58 through controller 59 to rotate the rod 54 and the cam 65 to release housing 32 from table assembly 14. A signal from the controller 59 is sent to solenoid 63 causing the stop rod 84 to be withdrawn from within table assembly 14 to a position at which stop rod 84 is not in a detent 80 and the housing 32 is pivoted on shaft 40 so that the bevel angle may be changed to a desired angle.

The user may then move the saw 10 so that the bevel angle is near or at a detent 80 and release the switch 25 to a first of the second momentary positions 25c, to release the rod 84 into a detent 80 in the table assembly 14. The user may also release the switch 25 to allow the rod 84 to engage the table assembly at a point where there is no detent 80, then move the saw 11 such that the stop rod 84 would snap into a detent 80 in the table assembly 14. The user may then allow the switch 25 to return to the “home” position 25a to lock the housing 32 in place. In other words, the two momentary positions 25c, 25d to the left control the detent function with the switch 25 all the way to the left and at a second momentary position 25d the detent would be out of play. With the switch 25 in the first momentary position 25c to the left the detent function is in play and the user may move the saw 10 and allow the stop rod 84 or rod 84 to snap into a detent 80 in the table assembly 14. On the other hand, if the user wanted to set the bevel angle to an angle that is not represented by a notch or detent in the detent plate 80, the user may push the switch 25 to the right to position 25b to cause both the bevel lock mechanism 30 to be unlocked and the rod 84 to be moved out of position. The user would then set the saw 10 to the desired bevel angle and release the switch 25. When the switch has returned to the “home” position 25a, the bevel lock mechanism 30 is locked and then, after a short delay, the rod 84 is released.

As would be apparent to one of ordinary skill in the art, the switch 25 having two positions 25c, 25d to the left may be replaced with a single switch position if another means is used to lock the bevel after the detent is in position. For example, a sensor (not shown) may be used to detect position of the detent and only lock the bevel after the detent is in position, or a time delay device may be used to lock the bevel after a predetermined time upon release of the detent.

Another switch embodiment would be to use 2 separate buttons. A first button is used if the user desired to set the saw to a preset detent. And a second button is used if the user desired to set the saw at a bevel angle between the detents.

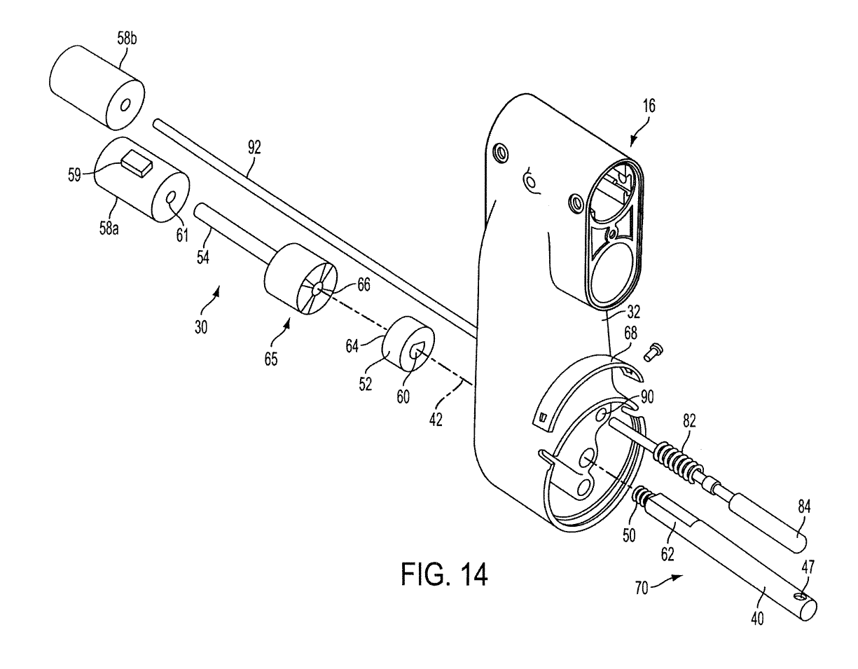

In an example embodiment, as shown in FIG. 14, two motors 58a, 58b may be used to separately release the bevel locking mechanism 30 and to control the bevel detent system 70. Further, the activation of the two motors 58a, 58b may be actuated by a single press or a double press of the switch 25, rather than a left and right motion. In an example embodiment, when the user activates the switch 25, both motors 58a, 58b are momentarily driven to both unlock the bevel lock 30 and lift the bevel detent latch 82 from its current position in the detent plate 80. This state is maintained as long as the user holds the switch 25 or button down. When the user releases the switch 25, the motors 58a, 58b are reversed to actuate the bevel detent system 70 and lock the bevel locking mechanism 30. Thus, if the user decides to set a bevel angle at a preset detent, the switch may be pressed one time and held down. When the desired detent position is approached, the switch 25 is released, causing the control circuit 59 to release the bevel detent latch 82 first, and then, after a delay, actuate the bevel locking mechanism 30 thereby allowing the user to set the saw to the desired detent match before the housing 16 is locked.

If the user desires to set the bevel angle using a bevel degree scale (e.g., a bevel angle not represented by a preset notch in the detent plate), the switch 25 is pressed twice and then held in place. When the bevel angle is at the desired location, the switch 25 is released causing the control circuit 59 to actuate the bevel locking mechanism 30, and then after a delay release the stop rod 84 or bevel detent thereby allowing the bevel angle to be set at any position without regard to the preset bevelled angles represented by notches in the bevel plate. In an embodiment the electric motor 58b may drive the stop rod 84 to lock the bevel angle, and the electric motor 58a may drive a rod 54 to lock the miter saw 10 in a bevelled position. The motor 58 may drive the threaded rod 54 through a gear reduction to generate sufficient torque and is actuated by a switch 25 mounted in the operating handle 24 of the miter saw 10. In an example embodiment the motor driven stop rod 84 may be used to lift or release detent latch 82 out of engagement with the detent plate 80. For example, the stop rod 84 may be connected at a first end to a drive motor 58 and a second end to the detent latch 82. The detent latch 82 may comprise spring steel that, when released, springs against the detent plate 80 at a desired location (FIG. 11).

The above detailed description describes different embodiments of the present invention. For example, persons skilled in the art will recognize that a motor/screw jack assembly can be replaced by a motor/actuator assembly to activate the bevel lock mechanism and the detent control system.

What is claimed is:

1. A power tool, comprising:
a bevel mechanism for selectively determining a bevel cutting angle of the power tool;
a bevel drive motor operably connected to the bevel mechanism that drives the bevel mechanism; and
a switch connected to the bevel drive motor that activates/deactivates the motor.

2. The power tool of claim 1, wherein the switch is mounted on an operating handle of the power tool.

3. The power tool of claim 1, further comprising:
a table on which a workpiece is placed;
a support housing supporting a cutting device and having a cutting motor for driving the cutting device.

4. The power tool of claim 3, wherein the bevel mechanism includes a locking mechanism that locks/unlocks the support housing to/from the table.

5. The power tool of claim 3, wherein the bevel mechanism includes a detent system and a positive stop system for selecting and setting a desired bevel angle of the cutting device relative to the table.

6. The power tool of claim 4, wherein the locking mechanism includes:
a rod rotatably driven by the bevel drive motor;
a first cam attached to the threaded rod, the first cam having a camming surface; and
a second cam disposed opposite the first cam, the second cam having a camming surface and being mounted on a shaft that passes through the support housing and is fixed in the table.

7. The power tool of claim 6, wherein the camming surface of the first cam and the camming surface of the second cam are in full contact alignment with each other and the cutting unit is rotatable about a pivot axis.

8. The power tool of claim 6, wherein the camming surface of the first cam and the camming surface of the second cam are mis-aligned with each other and the cutting unit is fixed to the table.

9. The power tool of claim 5, wherein the detent system includes:
at least one detent formed in the table;
a stop rod that passes through the support housing, the stop rod having a first end fixed within the bevel drive motor and a second end insertable into the at least one detent; and
a biasing spring between the table and the support housing, the biasing spring being disposed over the stop rod.

10. The power tool of claim 9, further comprising a controller that controls the bevel drive motor according to signals from the switch.

11. The power tool of claim 1, wherein the switch is a multi-positional switch.

12. The power tool of claim 1, further comprising a solenoid attached to the bevel drive motor.

13. The power tool of claim 5, further comprising a solenoid attached to the bevel drive motor, wherein the detent system includes:
at least one detent formed in the table;
a stop rod that passes through the support housing, the stop rod having a first end fixed within the solenoid and a second end insertable into the at least one detent; and
a biasing spring between the table and the support housing, the biasing spring being disposed over the stop rod.

14. A method of controlling setting of a bevel cutting angle on a power tool, comprising:
activating a motor using a switch to release a bevel lock mechanism of the power tool;
activating the motor using the switch to remove a stop from a detent of the power tool;
setting the power tool at a desired bevel cutting angle;
activating the motor to release the stop; and
activating the motor to lock the power tool at the desired bevel cutting angle.

15. The method of claim 14, wherein activating the motor using the switch in a first position drives a locking mechanism to allow a cutting unit of the power tool to rotate about an axis.

16. The method of claim 14, wherein activating of the motor using the switch in a second position releases a stop from a detent position in the power tool to allow for selecting and setting the bevel cutting angle.

17. The method of claim 14, wherein activating of the motor using the switch in a third position drives a locking mechanism to fix a cutting unit of the power tool at a desired bevel cutting angle.

18. The method of claim 14, wherein activating of the motor rotates a rod to misalign a camming surface fixed to an end of the rod relative to a camming surface of a cam fixed to a shaft that passes through a support housing of the power tool to push the support housing toward a table of the power tool to fix the support housing and the table in a position relative to one another.

19. The method of claim 14, wherein activating the motor using the switch to remove a stop from a detent of the power tool includes activating a solenoid to move the stop.

20. A power tool that includes a controlling button wherein:
Pressing the button once causes a function to occur
Pressing the button twice causes a different function to occur.
